(19) United States
(12) Patent Application Publication
(10) Pub. No.: US 2012/0158187 A1
(43) Pub. Date: Jun. 21, 2012

(54) MOUNTING APPARATUS FOR ADJUSTING SWIVELLING ANGLE OF DISPLAY DEVICE

(75) Inventor: Seok Ho Shin, Suwon-si (KR)

(73) Assignee: HUMAN ELECTRONICS CO., LTD., Gwangju (KR)

(21) Appl. No.: 13/393,238

(22) PCT Filed: Sep. 1, 2010
(86) PCT No.: PCT/KR10/05912

§ 371 Date: Feb. 29, 2012

(30) Foreign Application Priority Data
Sep. 1, 2009 (KR) 10-2009-0081981

(51) Int. Cl. H04N 5/655; G05D 3/12

(52) U.S. Cl. 700/275; 248/205.1

(57) ABSTRACT

An apparatus for adjusting a swivel angle of a display panel. The apparatus includes: a swivel frame configured to forwardly or reversely rotate in a first direction with respect to a reference surface; a panel mount bracket mounted on the swivel frame and allowing the display panel to be mounted thereon; a motor mounted on the swivel frame; and a driving force transmitting unit configured to receive a rotational force of the motor and drive the swivel frame to forwardly or reversely rotate, wherein the panel mount bracket is eccentrically disposed on a side of the swivel frame so that the display panel is spaced apart from the reference surface during rotation.

### TECHNICAL FIELD

The present invention relates to an apparatus for adjusting a swivel angle of a display panel, and more particularly, to an apparatus for affixing a display panel to a wall surface and for adjusting a swivel angle of the display panel.

### BACKGROUND ART

Flat panel display devices, such as flat panel computer monitors, liquid crystal displays (LCDs), and plasma display panels (PDPs), have recently emerged as major display devices. Flat panel display devices have advantages in that they may be manufactured to have a low thickness and a wide screen, unlike conventional cathode ray tubes that require a large longitudinal space. Such flat panel display devices have become increasingly popular because they may maximize space utilization and boost aesthetic appeal by being mounted on a wall surface.

However, once such flat panel display devices are mounted on a wall surface, it is difficult to adjust a viewing angle and/or a swivel direction, thereby causing a user inconvenience.

### DISCLOSURE OF INVENTION

### Technical Problem

The present invention provides an apparatus for adjusting a swivel angle of a display panel mounted on a wall surface by adjusting a viewing angle and/or a swivel direction of the display panel by using a driving force transmitting unit.

### Solution to Problem

According to an aspect of the present invention, there is provided an apparatus for adjusting a swivel angle of a display panel, the apparatus including: a swivel frame configured to forwardly or reversely rotate in a first direction with respect to a reference surface; a panel mount bracket mounted on the swivel frame and allowing the display panel to be mounted thereon; a motor mounted on the swivel frame; and a driving force transmitting unit configured to receive a rotational force of the motor and drive the swivel frame to forwardly or reversely rotate wherein the panel mount bracket is eccentrically disposed on a side of the swivel frame so that the display panel is spaced apart from the reference surface during rotation.

The swivel frame may be connected to a base frame coupled to the reference surface and the swivel frame may rotate in the first direction.

The driving force transmitting unit may include: a pivot shaft connected to the base frame; and a gear unit configured to convert a rotational force of a driving shaft of the motor to a rotational force for rotating the swivel frame about the pivot shaft in a direction perpendicular to the pivot shaft.

The gear unit may include: a first gear unit comprising a worm wheel mounted on the pivot shaft; and a second gear unit comprising a worm gear mounted on the driving shaft of the motor.

If an external force is applied by an obstacle while the swivel frame rotates and a rotational force greater than a predetermined force is applied to the first gear unit, the worm wheel may rotate about a center of the pivot shaft.

The first gear unit may include: the worm wheel rotatably mounted on the pivot shaft; washers disposed on both sides of the worm wheel; a disc spring washer disposed on one side of the washers; and a friction adjustment nut disposed on one side of the disc spring washer and screwed onto the pivot shaft, wherein a first end of the first gear unit is supported by a stepped portion of the pivot shaft on the pivot shaft, and a second end of the first gear unit is supported by the friction adjustment nut on the pivot shaft.

The panel mount bracket may be eccentrically disposed on a side of the swivel frame so that the display panel is spaced apart from the reference surface during rotation.

The panel mount bracket may be connected to pivot, in a direction perpendicular to the first direction, about a base bracket coupled to the swivel frame.

The apparatus may further include a control system for controlling a swivel angle of the swivel frame with respect to the reference surface, wherein the control system includes: a sensing unit for sensing a location of the swivel frame; a control unit for receiving the location of the swivel frame sensed by the sensing unit and outputting a control value; and a driving unit for receiving the control value and driving the motor.

### Advantageous Effects of Invention

According to the apparatus for adjusting the swivel angle of the display panel of the present invention, user convenience may be improved by automatically or manually adjusting the swivel direction of the display panel and safety is improved during operation thereof by using a safety device.

### BRIEF DESCRIPTION OF DRAWINGS

The above and other features and advantages of the present invention will become more apparent by describing in detail exemplary embodiments thereof with reference to the attached drawings in which:

FIG. 1 is a perspective view of an apparatus for adjusting a swivel angle of a display panel, according to an embodiment of the present invention;

FIG. 2 is a top view for explaining pivoting of the apparatus of FIG. 1;

FIG. 3 is an enlarged plan view of a driving force transmitting unit of the apparatus of FIG. 1, according to an embodiment of the present invention;

FIG. 4 is a cross-sectional view taken along a line VI-VI of FIG. 1;

FIG. 5 is a perspective view illustrating a structure that turns around a pivot shaft as a motor rotates, according to an embodiment of the present invention;

FIG. 6 is an exploded perspective view illustrating a first gear unit acting as a security device of the apparatus of FIG. 1, according to an embodiment of the present invention;

FIG. 7 is a side view of a panel mount bracket coupled to a swivel frame;

FIG. 8 is a side view of the panel mount bracket coupled to pivot about a base bracket;

FIG. 9 is a block diagram of a control system according to an embodiment of the present invention; and

FIG. 10 is a diagram for explaining a method of controlling a location of the swivel frame by using the control system of FIG. 9, according to an embodiment of the present invention.

### MODE FOR THE INVENTION

The present invention will now be described more fully with reference to the accompanying drawings, in which exemplary embodiments of the invention are shown.

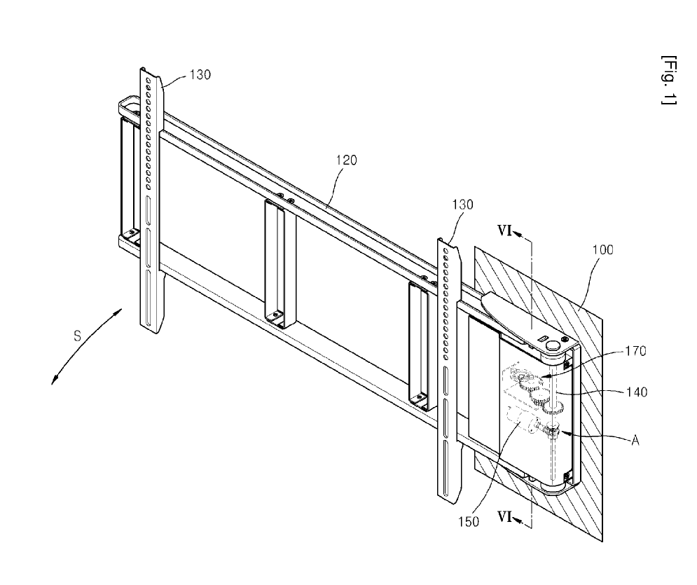

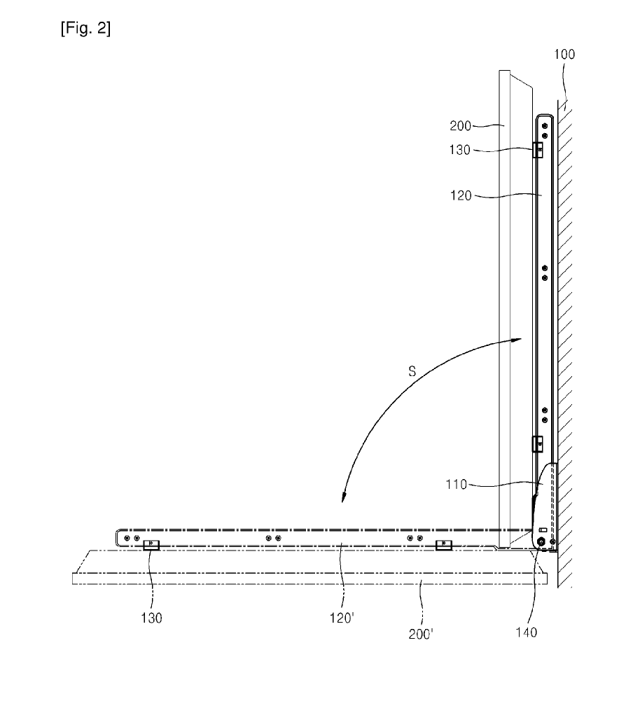

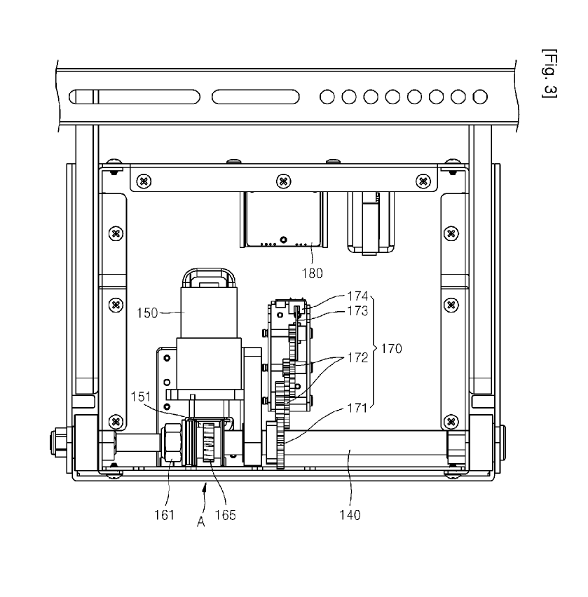

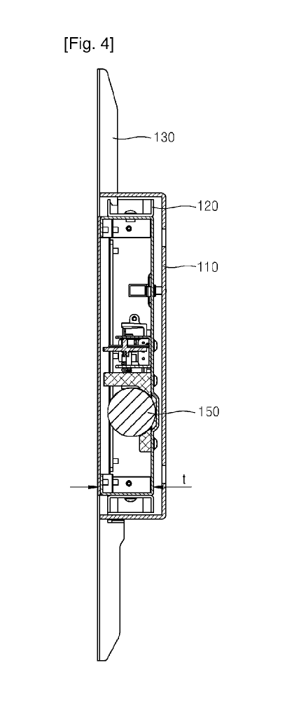

FIG. 1 is a perspective view of an apparatus for adjusting a swivel angle of a display panel, according to an embodiment of the present invention. FIG. 2 is a top view for explaining pivoting of the apparatus of FIG. 1. FIG. 3 is an enlarged plan view illustrating a driving force transmitting unit of the apparatus of FIG. 1, according to an embodiment of the present invention. FIG. 4 is a cross-sectional view taken along a line VI-VI of FIG. 1.

Referring to FIGS. 1 through 4, the apparatus includes a base frame 110, a swivel frame 120, panel mount brackets 130, a motor 150, and a driving force transmitting unit A.

The base frame 110 may be mounted on a support structure such as a wall or a reference surface 100. The swivel frame 120 is rotatably coupled to the base frame 110. As shown in FIG. 1, a pivot shaft 140 is coupled to the base frame 110, and the swivel frame 120 rotates about the pivot shaft 140.

Alternatively, the apparatus may not include the base frame 110, and may include the swivel frame 120, which may forwardly and reversely rotate in a first direction about the reference surface 100, the panel mount brackets 130 disposed on the swivel frame 120 and designed to be mounted by a display panel 200 thereon, and the driving force transmitting unit A for driving the swivel frame 120.

Although the swivel frame 120 may rotate up to 90° with respect to the reference surface 100 in counterclockwise and clockwise directions in FIG. 1 or 2, the present embodiment is not limited thereto. For example, a swivel angle is not limited to 90° and may be greater or less than 90° Also, the base frame 110 may be turned upside down and disposed on the reference surface 100 to change a swivel angle and a swivel direction.

The panel mount brackets 130 are attached to the swivel frame 120 and pivots, and the display panel 200 is mounted on the panel mount brackets 130. In this case, the panel mount brackets 130 attached to the swivel frame 120 may be located on the swivel frame 120 far away from the pivot shaft 140 so that the display panel 200 is spaced apart from the reference surface 100 during rotation. Thus, the display panel 200 may not contact the reference surface 100 while the swivel frame 120 rotates.

A midpoint between two of the panel mount brackets 130 is located on the swivel frame 200 far away from the pivot shaft 140 in FIG. 1. Accordingly, since the midpoint between the panel mount brackets 130 is far away from the pivot shaft 140, an end portion of the display panel 200 at a pivot shaft side may be prevented from colliding with the reference surface 100.

The motor 150 is disposed on the swivel frame 120, and the driving force transmitting unit A is connected to the motor 150 and rotates the swivel frame 120 about the base frame 110.

As the motor 150 operates, the swivel frame 120 may rotate in a direction S about the pivot shaft 140 to become a first position swivel frame 120 as shown in FIG. 2.

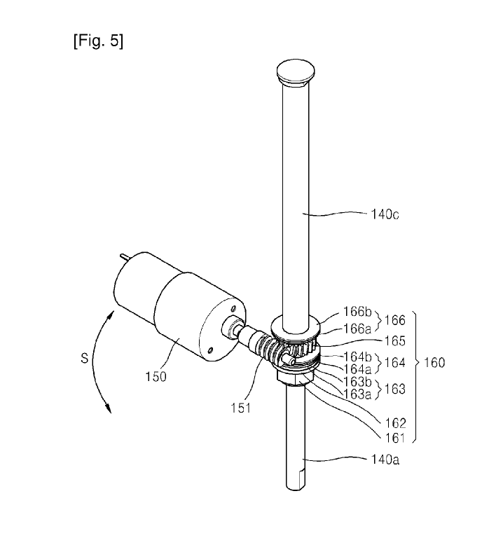

Rotation of the swivel frame 120 about the pivot shaft 140 of the base frame 110 as the motor 150 operates will now be explained with reference to FIG. 5. FIG. 5 is a perspective view illustrating a structure that turns around the pivot shaft 140 as the motor 150 rotates, according to an embodiment of the present invention.

Referring to FIG. 5, the driving force transmitting unit A includes gear units and the pivot shaft 140. Here, the gear units include a first gear unit 160 frictionally disposed on the pivot shaft 140, and a second gear unit 151 connected to the motor 150. The pivot shaft 140 is fixedly disposed on the base frame 110. As the motor 150 rotates, the second gear unit 151 turns around the first gear unit 160, which is frictionally disposed on the pivot shaft 140, and thus the motor 150 also turns around the pivot shaft 140. As the motor 150 rotates about the pivot shaft 140, the swivel frame 120, on which the motor 150 is mounted, also rotates about the pivot shaft 140. In this case, the first gear unit 160 may include a worm wheel, and the second gear unit 151 may include a worm gear. Accordingly, the worm wheel of the first gear unit 160 and the worm gear of the second gear unit 151 may be coupled to each other in such a way that shafts of the first gear unit 160 and the second gear unit 151 are perpendicular to each other.

Assuming that while the swivel frame 120 rotates, the swivel frame 120 encounters an obstacle, such as a human body, and an external force is applied to the swivel frame 120, if a repulsive force of the obstacle is greater than a rotational force of the motor 150, and thus the motor 150 may not be able to rotate, an overload may be applied to the motor 150. Assuming that while the swivel frame 120 rotates, the swivel frame 120 encounters the obstacle and the external force is applied to the swivel frame 120, if the rotational force of the motor 150 is greater than the repulsive force of the obstacle, the swivel frame 120 may not stop rotating, thereby causing a safety-related problem. In particular, if the obstacle is a child, the child may be seriously damaged. In this case, the first gear unit 160 acts as a safety device by idly rotating.

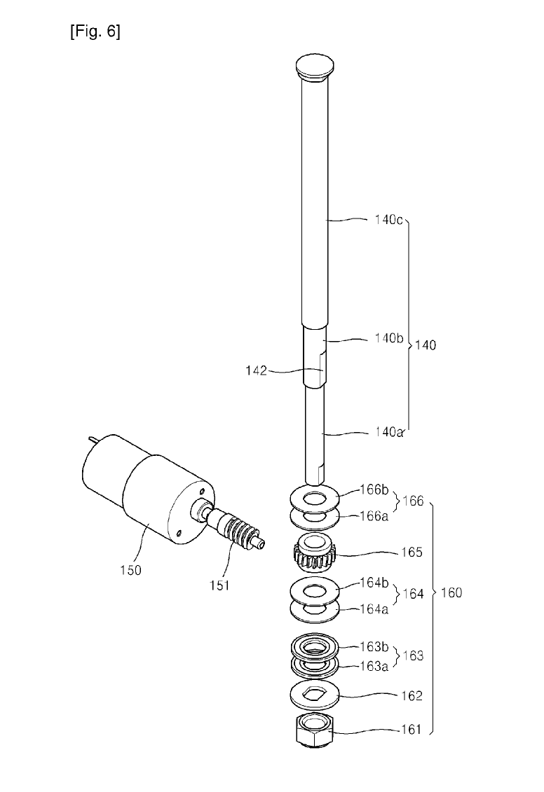

A safety function of the first gear unit 160 will now be explained with reference to FIG. 6. FIG. 6 is an exploded perspective view of the first gear unit 160 acting as a safety device of the apparatus of FIG. 1, according to an embodiment of the present invention. In FIG. 6, the pivot shaft 140 includes a small diameter portion 140a, an intermediate diameter portion 140b, and a large diameter portion 140c. Due to such a diameter difference of the pivot shaft 140, the pivot shaft 140 has a stepped portion. The intermediate diameter 140b has a screw groove formed therein, and also includes a slip lock washer stopping jaw 142 engaging with a slip lock washer 162 to stop rotation of the slip lock washer 162.

When a friction adjustment nut 161 is screwed onto the screw groove 142 of the intermediate diameter portion 143, elements of the first gear unit 160 may be frictionally supported due to a clamping force between the stepped portion 141 of the pivot shaft 140 and the friction adjustment nut 161.

The first gear unit 160 includes the friction adjustment nut 161, the slip lock washer 162, a disc spring washer 163 including a first disc spring washer 163a and a second disc spring washer 163b, a first washer unit 164, a first gear 165, and a second washer unit 166.

An inner shape of the slip lock washer 162 conforms to an outer shape of the slip lock washer stopping jaw 143 so as not to rotate. Since the slip lock washer 162 does not rotate, even when the first or second washer 164 or 166 or the disc spring washer 163 rotates, a rotational force of the first or second washer 164 or 166 or the disc spring washer 163 is not transmitted to the friction adjustment nut 161, thereby preventing the friction adjustment nut 161 from being loosened. The first and second disc spring washers 163a and 163b elastically support a tightening force of the friction adjustment nut 161 due to their elasticity. The first washer 164 including first washers 164a and 164b and the second washer 166 including second washers 166a and 166b are disposed on respective side surfaces of the first gear 165.

In this case, since the first gear 165 does not rotate and is fixed due to the tightening force of the friction adjustment nut 161, the second gear unit 151 of the motor 150 may engage with the first gear 165 and may rotate. However, if the swivel frame 120 is obstructed by an obstacle and a rotational force greater than a friction force applied by the friction adjustment nut 161 is applied to the first gear 165, the first gear 165 may idly rotate alone or along with some of the elements of the first gear unit 160 due to a rotational force applied by the second gear unit 151. In this case, it is highly possible that an idle rotation may occur between the first washer 164a and the first washer 164b and between the second washer 166a and the second washer 166b. Since the elements of the first gear unit 160 and the second gear unit 151 idly rotate in this way, the first gear unit 160 may act as a safety device against an obstacle while preventing an unnecessary load from being applied to the motor 150. Here, since a friction force applied to the first gear 165 may be adjusted by using the tightening force of the friction adjustment nut 161, the friction force may be adjusted as needed for safety reasons.

Although the first gear unit 160 is configured as shown in FIG. 6, the present embodiment is not limited thereto, and the first gear unit 160 may be configured in various ways and it will be understood by one of ordinary skill in the art that the elements in the first gear unit 160 may be replaced with equivalents.

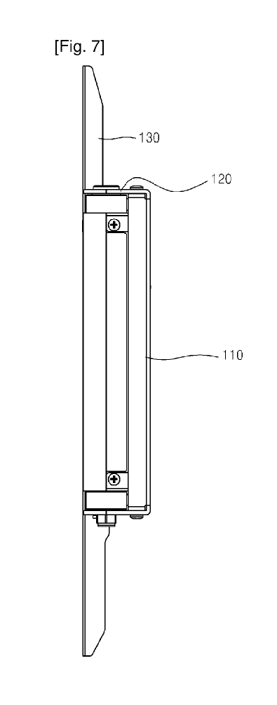

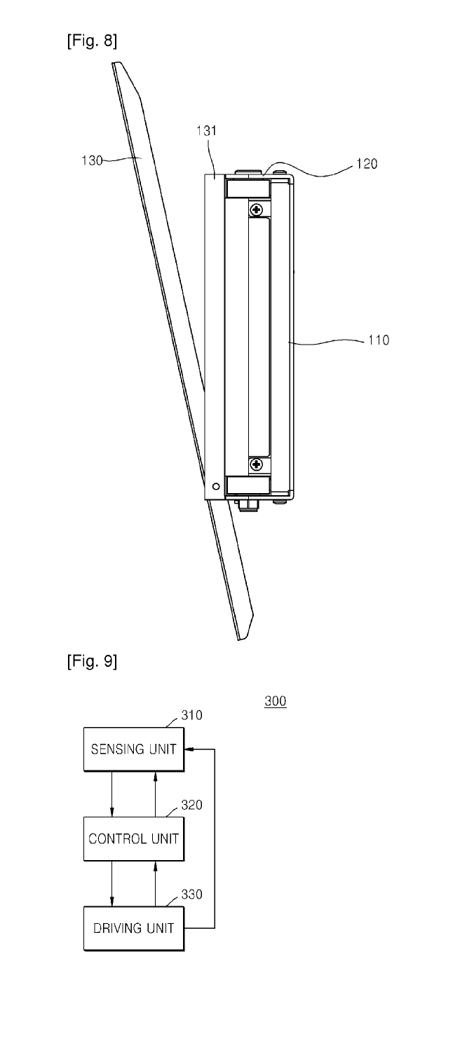

A function and a structure of the panel mount brackets 130 will now be explained with reference to FIG. 7 or 8. FIG. 7 is a side view of one of the panel mount bracket 130 coupled to the swivel frame 120. FIG. 8 is a side view of the panel mount bracket 130 coupled to pivot about a base bracket 131.

For example, referring to FIG. 7, the panel mount bracket 130 may be directly mounted on the swivel frame 120 and may rotate along with the swivel frame 120. Alternatively, referring to FIG. 8, the base bracket 131 is additionally mounted on the swivel frame 120 and the panel mount bracket 130 is mounted on the base bracket 131. In this case, the panel mount bracket 130 may pivot about the base bracket 131 to tilt in a gravity direction by a user or the like manually adjusting a viewing angle of the panel mount bracket 130 by using a fixing groove (not shown). In order to manually adjust the viewing angle of the panel mount bracket 130 in this way, for example, the panel mount bracket 130 may be connected to the base bracket 131 to pivot about the base bracket 131, and the fixing groove or the like may be formed in the base bracket 131 so that the panel mount bracket 130 may be coupled to the base bracket 131 at any of various angles. Accordingly, the user or the like may adjust an angle between the base bracket 131 and the panel mount bracket 130 according to need. Although the viewing angle of the panel mount bracket 130 is adjusted manually in FIG. 7 or 8, the present embodiment is not limited thereto and the viewing angle of the panel mount bracket 130 may be adjusted automatically.

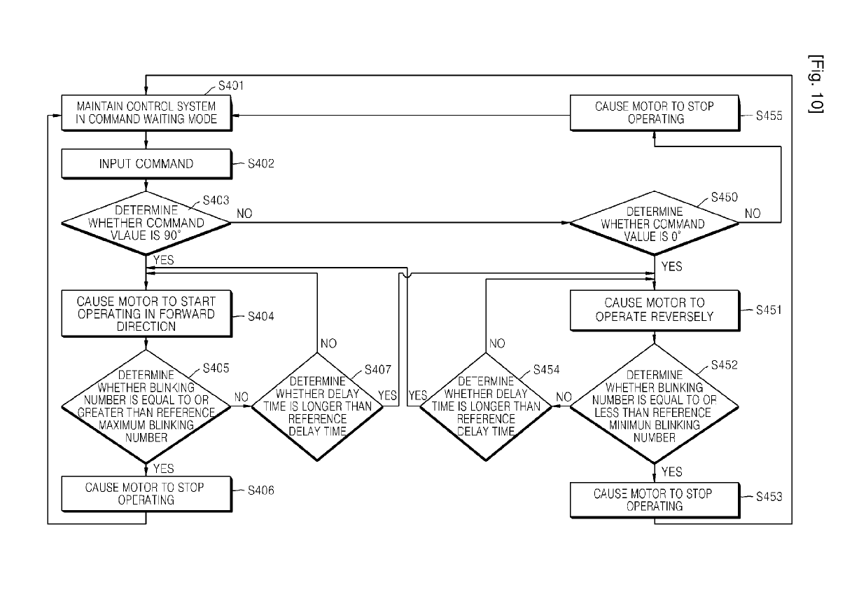

FIG. 9 is a block diagram of a control system 300 according to an embodiment of the present invention. FIG. 10 is a diagram illustrating a method of controlling a location of the swivel frame 120 by using the control system 300 of FIG. 9, according to an embodiment of the present invention. The control system 300 for controlling a swivel angle of the swivel frame 120 with respect to the base frame 110 or a support structure will now be explained with reference to FIG. 9 or 10.

Referring to FIG. 9, the control system 300 may include a sensing unit 310, a control unit 320, and a driving unit 330. The sensing unit 310 senses a location of the swivel frame 120 with respect to a reference surface. The control unit 320 receives the location of the swivel frame 120 from the sensing unit 310 and outputs a control value. The driving unit 330 receives the control value output from the control unit 320 and operates the motor 150.

Although the sensing unit 310 of the control system 300 may include a sensor first gear 171, a sensor gear unit 172, a slot rotator 173, and a sensor 174 as shown in FIG. 3, the present embodiment is not limited thereto and the sensing unit 310 of the control system 300 may be configured in various ways.

Referring to FIG. 3, the sensor first gear 171 is fixedly disposed on the pivot shaft 140. As the swivel frame 120 rotates, a gear of the sensor gear unit 172 is rotated by the sensor first gear 171 and the slot rotator 173 having a slot formed in a plane rotates due to the rotation of the sensor gear unit 172. As the slot rotator 173 rotates, the sensor 174 having a U shape senses the swivel angle of the swivel frame 120 about the pivot shaft 140 by using the number of times light is allowed and blocked by the slot formed in the slot rotator 173.

In order to measure the swivel angle of the swivel frame 120 with respect to the reference surface 100 of the base frame 110 by using a rotation of the slot rotator 173 in the sensor 174, for example, the sensor 174 may be configured in such a way that when the swivel frame 120 rotates 5° the slot of the slot rotator 173 in the sensor 174 allows and blocks light one time. Accordingly, when the slot allowed and blocked light ten times, the sensor 174 recognizes that the swivel frame 120 has rotated 50°

FIG. 10 is a diagram illustrating a method of controlling the swivel angle of the swivel frame 120 by using the control system 300, according to an embodiment of the present invention. In FIG. 10, an initial value is set to 0° the swivel frame 120 rotates 90° when a command is received, and the swivel frame 120 returns to its initial value, that is, its value before receiving the command, when the swivel frame 120 encounters an obstacle during rotation. However, the present embodiment is not limited thereto and it will be understood by one of ordinary skill in the art that the control system 300 may be configured in various ways.

Referring to FIG. 10, in operation S401, before receiving a command value, the control system 300 is maintained in a command waiting mode. In this case, a user may send, as a command value, one of 90° rotation, 0° rotation, and stop commands. The 90° rotation command is a command for rotating the swivel frame 120 90° from a reference value, the 0° command is a command for returning the swivel frame 120 having already rotated 90° to the original reference value, and the stop command is a command for stopping operations. In operation S402, a command is input. In operation S403, it is determined whether the command value is 90° If it is determined in operation S403 that the command value is 90° the method proceeds to operation S404. In operation S404, the motor 150 starts operating in a forward direction. However, the command value is not limited to 90° and may be any of various values.

In operation S405, the control system 300 determines a rotation of the slot rotator 173 sensed by the sensor 174. In this case, the sensor 174 may define and recognize a range of a swivel angle in which the swivel frame 120 may rotate. Although the swivel frame 120 rotates in a range from 0° to 90° in FIG. 10, the present embodiment is not limited thereto. For example, the swivel frame 120 may rotate in a range from 20° to 70° or from 0° to 120° In this case, the swivel angle may be controlled by using the rotation of the slot rotator 173, or may be controlled by inputting a maximum blinking number and a minimum blinking number of light allowed and blocked due to rotation of the slot of the slot rotator 173 in a forward direction and a reverse direction. For example, assuming that the swivel frame 120 may be able to rotate 110° about the reference surface 100 but actually rotates only in a range from 50° to 100° if the slot rotator 173 is adjusted to blink one time whenever the swivel frame 120 rotates 5° a minimum blinking number is 10 and a maximum blinking number is 20. When the slot rotator 173 rotates in the forward direction, the sensor 174 recognizes that a blinking number is increased, and when the slot rotator 173 rotates in the reverse direction, the sensor recognizes that a blinking number is reduced. In this way, the sensor 174 may sense and control the swivel angle of the swivel frame 120 by using a blinking number. Also, the command may be carried out by stopping operating of the motor 150 when a blinking number reaches a maximum blinking number or a minimum blinking number. Accordingly, in operation S405, a blinking number is recognized and it is determined whether the blinking number is equal to or greater than a reference maximum blinking number or a reference minimum blinking number. If it is determined in operation S405 that the blinking number is equal to or greater than the reference maximum blinking number, the method proceeds to operation S406. In operation S406, the motor stops operating and the method returns to operation S401.

While the sensor 174 is measuring the blinking number, the rotation of the swivel frame 120 may be obstructed by an obstacle. In this case, in operation S407, the sensor 174 reversely rotates the motor 150 if it is determined that a delay time during which the blinking number is no longer increased from a predetermined blinking number is longer than a predetermined reference delay time.

If it is determined in operation S403 that the command value is not 90° the method proceeds to operation S450. In operation S450, it is determined whether the command value is 0° If it is determined in operation S450 that the command value is 0° the method proceeds to operation S451. In operation S451, the motor operates reversely. Operation S451 occurs when the swivel frame 120 has already rotated 90 and then the user wants to return the swivel frame 120 to its original position.

In operation S452, the sensor 174 determines whether a blinking number of light allowed and blocked due to rotation of the slot of the slot rotator 173 is equal to or less than a reference minimum blinking number during the operation. If it is determined in operation S452 that the blinking number is equal to or less than the reference minimum blinking number, the method proceeds to operation S453. In operation S453, the motor stops operating and the method returns to operation S401.

While the sensor 174 is measuring the blinking number, the rotation of the swivel frame 120 may be obstructed by an obstacle. In this case, in operation S454, the sensor 174 may calculate a delay time during which the blinking number is no longer increased from a predetermined blinking number, determine that the rotation of the swivel frame 120 is obstructed by the obstacle if the delay time is longer than a predetermined delay time, and rotate the swivel frame 120 in a direction opposite to the obstacle by forwardly rotating the motor 150.

If it is determined in operation S450 that the command value is not 0, the method proceeds to operation S455. In operation S455, the motor 150 stops operating and the method returns to operation S401.

Although the control system 300 may reverses the swivelling direction of the swivel frame 120 when the swivel frame 120 is obstructed by an obstacle during rotation in FIG. 10, the present embodiment is not limited thereto and the control system 300 may be configured in such a way that when the swivel frame 120 is obstructed by an obstacle during rotation, the motor 150 stops operating to stop the rotation of the swivel frame 120.

According to the apparatus for adjusting the swivel angle of the display panel of the present invention, user convenience may be improved by automatically or manually adjusting the swivel direction of the display panel and safety is improved during operation thereof by using a safety device.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the scope of the invention is defined not by the detailed description of the invention but by the appended claims.

### INDUSTRIAL APPLICABILITY

The apparatus for adjusting the swivel angle of the display panel according to the present invention may be used in all industries where a loading table of a display panel is manufactured and used.

1. An apparatus for adjusting a swivel angle of a display panel, the apparatus comprising:
a swivel frame configured to forwardly or reversely rotate in a first direction with respect to a reference surface;
a panel mount bracket mounted on the swivel frame and allowing the display panel to be mounted thereon;
a motor mounted on the swivel frame; and
a driving force transmitting unit configured to receive a rotational force of the motor and drive the swivel frame to forwardly or reversely rotate,
wherein the panel mount bracket is eccentrically disposed on a side of the swivel frame so that the display panel is spaced apart from the reference surface during rotation.

2. The apparatus of claim 1, wherein the swivel frame is connected to a base frame coupled to the reference surface and the swivel frame rotates in the first direction.

3. The apparatus of claim 2, wherein the driving force transmitting unit comprises:
a pivot shaft connected to the base frame; and
a gear unit configured to convert a rotational force of a driving shaft of the motor to a rotational force for rotating the swivel frame about the pivot shaft in a direction perpendicular to the pivot shaft.

4. The apparatus of claim 3, wherein the gear unit comprises:
a first gear unit comprising a worm wheel mounted on the pivot shaft; and
a second gear unit comprising a worm gear mounted on the driving shaft of the motor.

5. The apparatus of claim 4, wherein if an external force is applied by an obstacle while the swivel frame rotates and a rotational force greater than a predetermined force is applied to the first gear unit, the worm wheel rotates about a center of the pivot shaft.

6. The apparatus of claim 5, wherein the first gear unit comprises:
the worm wheel rotatably mounted on the pivot shaft;
washers disposed on both sides of the worm wheel;
a disc spring washer disposed on one side of the washers; and
a friction adjustment nut disposed on one side of the disc spring washer and screwed onto the pivot shaft,
wherein a first end of the first gear unit is supported by a stepped portion of the pivot shaft on the pivot shaft, and a second end of the first gear unit is supported by the friction adjustment nut on the pivot shaft.

7. The apparatus of claim 1, wherein the first direction is different from a gravity direction.

8. The apparatus of claim 1, wherein the first direction is perpendicular to a gravity direction.

9. The apparatus of claim 1, wherein the panel mount bracket is connected to pivot, in a direction perpendicular to the first direction, about a base bracket coupled to the swivel frame.

10. The apparatus of claim 1, further comprising a control system for controlling a swivel angle of the swivel frame with respect to the reference surface,
wherein the control system comprises:
a sensing unit for sensing a location of the swivel frame;
a control unit for receiving the location of the swivel frame sensed by the sensing unit and outputting a control value; and
a driving unit for receiving the control value and driving the motor.

11. The apparatus of claim 10, wherein the sensing unit comprises a sensor located on one surface of the swivel frame and designed to measure the number of times the swivel frame rotates with respect to the reference surface.
